(19) United States
(12) Patent Application Publication
(10) Pub. No.: US 2008/0221857 A1
(43) Pub. Date: Sep. 11, 2008

(54) METHOD AND APPARATUS FOR SIMULATING THE WORKLOAD OF A COMPUTE FARM

(76) Inventor: Andrea Casotto, Fremont, CA (US)

Correspondence Address: GLENN PATENT GROUP, 3475 EDISON WAY, SUITE L, MENLO PARK, CA, 94025, US

(21) Appl. No.: 12/041,602

(22) Filed: Mar. 3, 2008

Related U.S. Application Data
(60) Provisional application No. 60/904,780, filed on Mar. 5, 2007.

(51) Int. Cl. G06F 9/455

(52) U.S. Cl. 703/21

(57) ABSTRACT

A method for simulating the workload of a compute farm produces simulation data that include statistics about executed jobs and the use of the compute farm's resources. The simulation data can be further generated in response to a plurality of “what-if” scenarios, in which different operation scenarios of the compute farm can be defined and the workload simulated for each such scenario. In accordance with another embodiment, a method for simulating the workflow in a computing farm is disclosed.

### CROSS REFERENCE TO RELATED APPLICATIONS

This application claims priority from U.S. provisional patent application Ser. No. 60/904,780, filed Mar. 5, 2007, the contents of which are incorporated herein in their entirety by this reference thereto.

### BACKGROUND OF THE INVENTION

1. Technical Field

The invention relates generally to a distributed computing environment, and more particularly to a method for simulation of the workload in a distributed computing environment.

2. Discussion of the Prior Art

To deliver increased computing capacity to users, companies are increasingly using compute farms to perform vast amounts of computing tasks and services efficiently. A compute farm can be defined generally as a group of networked servers or, alternatively, as a networked multi-processor computing environment, in which work is distributed between multiple processors. The major components of the compute farm architecture include applications, central processors (CPUs), and respective memory resources, operating systems, a network infrastructure, a data storage infrastructure, load-sharing and scheduling mechanisms, in addition to means for monitoring and tuning the compute farm. Typically, compute farms provide more efficient processing by distributing the workload between individual components or processors of the farm. As a result, execution of computing processes is expedited by using the available power of multiple processors.

FIG. 1 shows a schematic diagram of a compute farm 100 that includes a plurality of workstations 110, a distributed resource manager (DRM) 120, and a plurality of remote computers 130. Users create and submit a job request from workstations 110. The remote computers 130 provide computing means configured to execute jobs submitted by users of the system 100. The DRM 120 performs numerous tasks, such as tracking jobs' demand, selecting machines on which to run a given submitted job, and prioritizing and scheduling jobs for execution. Examples for DRM systems are the load-sharing facility (LSF) provided by Platform Computing™, Sun Grid Engine, OpenPBS, NetworkComputer provided by Runtime Design Automation, and the like.

A job submitted by a user can be executed on a remote computer 130 if there are available resources that are required for the execution of the job. The resources include software resources, such as the application's licenses, and hardware resources, such as CPUs, memory, network bandwidth, and so on. If a submitted job that cannot be executed immediately, it is queued until all required resources are available. Therefore, if a compute farm has limited resources, users may have to wait a substantial time until their jobs are scheduled for execution. As a result, jobs may complete late.

Organizations and enterprises can invest money in upgrading their compute farms, for example, by adding more application licenses and more hardware resources. However, this may not improve the performance of the farm because the causes for bottlenecks, in most, cases are unknown. For example, an organization may upgrade its farm by adding powerful computers, but if there is a lack of application licenses the waiting time may not be improved. Presently, there is no existing tool for simulating the workload of the farm and providing analysis pointing out the critical resources.

It would be therefore advantageous to provide a solution for monitoring the workload of a compute farm, for providing detailed analysis on the use of resources in the farm, and for predicting the effects of adding or removing selected resources.

### SUMMARY OF THE INVENTION

A method for simulating the workload of a compute farm produces simulation data that include statistics about executed jobs and the use of the compute farm's resources. The simulation data can be further generated in response to a plurality of “what-if” scenarios, in which different operation scenarios of the compute farm can be defined and the workload simulated for each such scenario. In accordance with another embodiment, a method for simulating the workflow in a computing farm is disclosed.

### BRIEF DESCRIPTION OF THE DRAWINGS

FIG. 1 is a schematic diagram of a compute farm (prior art);

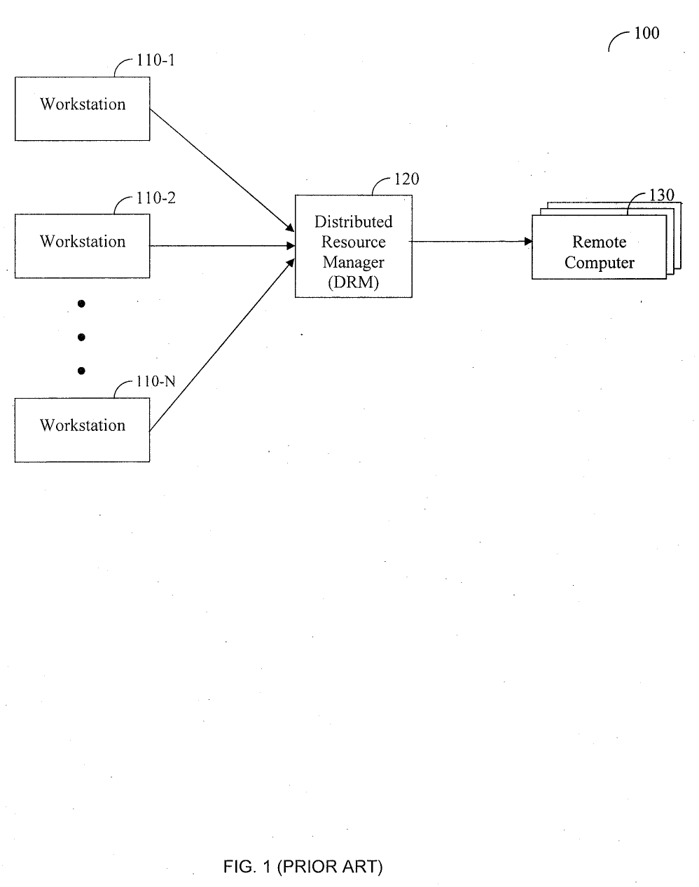

FIG. 2 is a flowchart describing a method for simulating the workload of a compute farm in accordance with an embodiment of the invention;

FIG. 3 is a schematic diagram illustrating the various states in which a job can exist in accordance with the invention; and

FIG. 4 is an exemplary simulation data report generated in accordance with the invention.

### DETAILED DESCRIPTION OF THE INVENTION

An embodiment of the invention, provides a method for simulating the workload of a compute farm. The method produces simulation data that includes statistics about executed jobs and the use of the compute farm's resources. The simulation data can be further generated in response to a plurality of “what-if” scenarios, in which different operation scenarios of the compute farm can be defined and the workload simulated for each such scenario. In accordance with another embodiment, a method for simulating the workflow in a computing farm is disclosed.

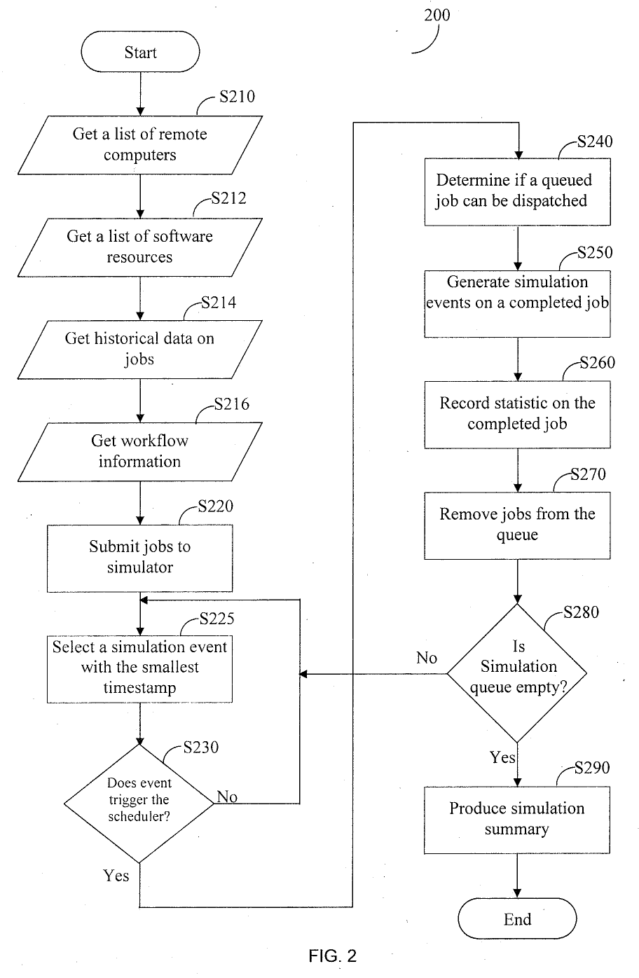

FIG. 2 is a flowchart 200 showing a method for simulating the workload of a compute farm in accordance with an embodiment of the invention. At step S210, a list of the remote computers at the compute farm that are to be simulated, e.g. computers 130, is received, together with their respective attributes. Specifically, for each remote computer some or all of the following attributes are defined: a computer name, a creation time, an expiration time, a computing power index, an operating system type, and properties of hardware resources, such as memory size, a CPU speed, a number of CPUs, and so on. The creation time refers to the time at which a remote computer becomes available to the farm. The expiration time refers to the time at which the computer turns off-line. The computing power index is a normalized number that determines the processing speed of a job on a reference remote computer relative to other computers in the farm. For example, if the computing power index of a referenced remote computer is 1000 and another computer in the farm executes the same job twice as fast, then the computing power index of the other computer is 2000.

At step S212, a list of software resources, e.g. application licenses, and their attributes is received. For each software resource, the following attributes are specified: a name, a type, a creation time, an expiration time, a number that represents the available resource, and so on. The creation time of both software and hardware resources refer to time varying resources, i.e. resources that are available at predefined times, e.g. weekends, after working hours, and so on.

At step S214, historical data about jobs executed by the compute farm are received. For each job the following data may be provided: a submission time, hardware and software resources required for execution, an owner of the job, e.g. a user and a group, a job class, an expected duration time for executing a job, and so on. The expected duration time is the time elapsed between starting the execution of the job and ending the execution of the job on a reference remote computer. The reference remote computer is a machine with a normalized computing power index. The historical data are gathered from real data of the compute farm, i.e. it includes the information on actual jobs submitted by users during a predefined time in the past, e.g. one month.

At step S216, workflow information is received. This information defines dependencies, i.e. additional constraints on the ordering in which jobs should be submitted for execution. The workflow information can be defined by a user or generated from the historical data.

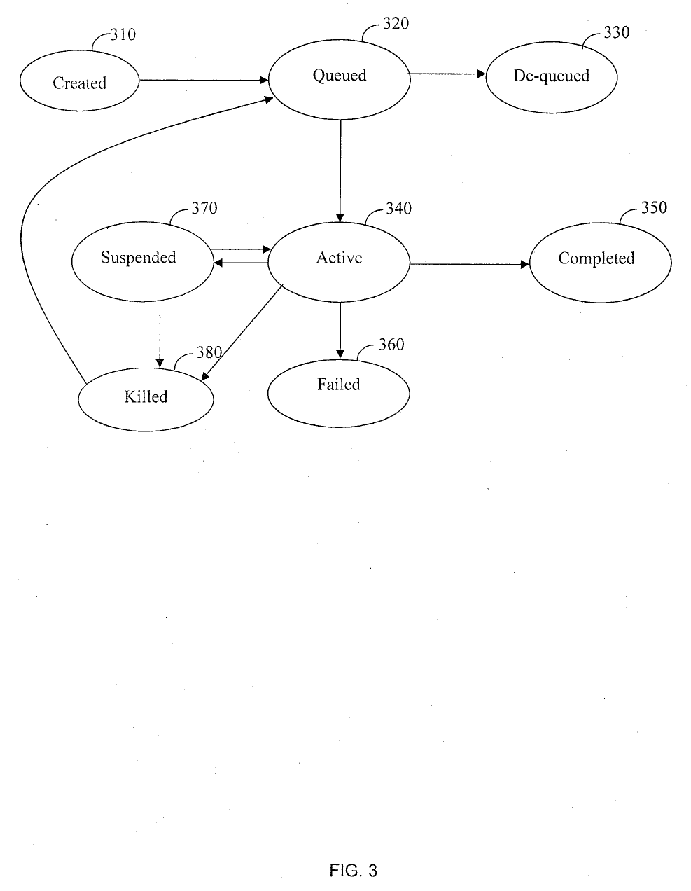

Once all inputs are received, the simulation begins at step S220, where jobs provided at step S214 are submitted to the simulator according to the workflow information provided at step S216. Each job submitted to the simulator has its own state, which determines the behavior of the job and limits the subsequent states to which the job can transition. The states in which a job can exist are shown in FIG. 3.

When a job is first created, it is in the created state 310, which is the starting state for all jobs. A job moves from the created state 310 to the queued state 320 when it is submitted and waiting to be scheduled for execution. The queued state 320 denotes that the job has been scheduled, but it has not yet been sent to the compute farm for execution. The de-queued state 330 denotes that a job is removed from the queue, most likely because its wait time exceeded a predefined threshold. Jobs waiting too long are de-queued automatically by the simulator. When the job meets the criteria for execution, its state is changed from the queued state 320 to the active state 340. The criteria that allows a job to move from the queued state 320 to the active state 340 may include the availability of the resources requested by the job resulting from the completion of a previous job that was holding some of such resources, or the completion of an interdependent job or task, preemption of an interdependent job or task and so on. A job that completes its execution without error passes from the active state 340 to the completed state 350, which denotes that the job has successfully completed. A job that fails to complete its execution changes from the active state 340 to the failed state 360. A job can be further set to the suspended state 370 when it is in the active state 340. On the other hand, a job can transit from the suspended state 370 to the active state 340, e.g. when the job is not longer suspended. All jobs provided at step S214 are at the created state 310.

In accordance with one embodiment of the invention, the simulator (or the simulation process) is an event-driven process. That is, the simulator processes an ordered list of simulation events kept in the simulation queue, and terminates when the simulation queue is empty. These events include, but are not limited to, a software resource is created or increased, a software resource expires or is reduced, a remote computer is available, a remote computer is off-line, a job is scheduled to be executed, i.e. a job transits from a created state 310 to a queued state 320, a job terminates, i.e. a job transits from an active state 340 to a completed state 350, and a remote computer completes the execution of a job, i.e. a job moves to the completed state 350. Each simulation event has its own timestamp.

At step S225, an event with the smallest timestamp (T_{C}=current simulation time) is selected, and is removed from the simulation queue to be processed. It should be noted that if two or more events have the same timestamp, the order in which such events are processed should not affect the outcome of the simulation. Processing of a simulation event may generate new simulation events. If there are no simulation events to process, i.e. the simulation queue is empty, then the execution terminates. At step S230, a check is made to determine if the selected simulation event triggers a request to call a scheduler of the compute farm, e.g. DRM 130, and if so execution continues at step S240; otherwise, execution returns to step S225.

At step S240, the scheduler determines if any of the queued jobs can be executed, i.e. if a queued job can be dispatched to a remote computer. The scheduler dispatches a job for execution if there are available computers and software resources, e.g. licenses, required to execute the job. Jobs are scheduled for execution by the simulator according to a policy carried out by the scheduler of the farm. In accordance with one embodiment of the invention, a simulation process emulates the operation of an event-driven scheduler, such as the one provided by Runtime Design Automation. The operation of the event-driven scheduler may be viewed as distributing jobs to be executed on available remote computers in the list of remote computers, where each change in the job's state may generate an event that is saved in the simulation event queue.

At step S250, upon dispatching a job to one or more remote computers using a set of software resources, the job's state is changed from a queued state 320 to an active state 340, and a new set of simulation events are generated. These events include at least one of: a job termination event at time T=T_{C}+L_{S}+X+L_{F}, i.e. a job transits from an active state 340 to a complete state 350, a release of the software resources event at the same time T=T_{C}+L_{S}+X+L_{F}, and a reopen of a remote computer(s) event at time T=T_{C}+L_{S}+X+L_{F}+L_{R}. The timestamps of these events depend on the execution time (X) of the job and on a number of parameters {L_{S}, L_{F}, L_{R}, . . . } which are used to represent the latency of various components in the farm. For example, there could be a starting latency (L_{S}) that describes the time it actually takes to start the job after dispatching it to a remote host, a finish latency (L_{F}) that describes the time it takes to collect the status of a job that has finished, and a reopen latency (L_{R}) that describes the time it takes to a remote host to be ready to accept another job after completion of a previous job. T_{C} is the current simulation time. The execution time (X) is computed using the expected duration time of the job and the relative power of the remote computer. For example, if the expected duration time is one hour, on a computer having a computing power index of 1000, and the remote computer has a computing power index of 4000, then the execution time and the timestamp is 15 minutes. In accordance with another embodiment of the invention, each job has includes an expected duration and a CPU time required for the execution. While executing the job on a different computer, only the CPU time is affected by the computing power index of this computer. For example, a job executed on a given computer (machine) has an expected duration of one hour and a CPU time of five minutes. If the job is executed on another computer that is twice as fast, only the CPU time is reduced, leading to an expected duration of 57 minutes and 30 seconds.

At step S260, statistical information about the completed, or de-queued, job is recorded. The statistical information may include, but is not limited to, duration of execution time, wait time, the time that the job was submitted, a time that the job started, and so on. At step S270, the completed job is removed from the system queue, and at step S280 a check is made to determine if the simulation queue is empty, i.e. if all the simulation events were processed. If so, execution continues at step S290, where the simulation data are produced; otherwise, execution returns to step S225.

The simulation data are generated for various groups of jobs and include, for each such group, at least the average execution duration, the average waiting time, the maximum waiting time, the submission time of the first job, the start time of the first job, the completion time of the last job, and the number of jobs that were de-queued without being executed. The groups may be defined to include any of: all jobs, jobs belonging to the same user, jobs belonging to the same group, jobs having the same priority, jobs using the same resources, jobs in the same job class, and so on.

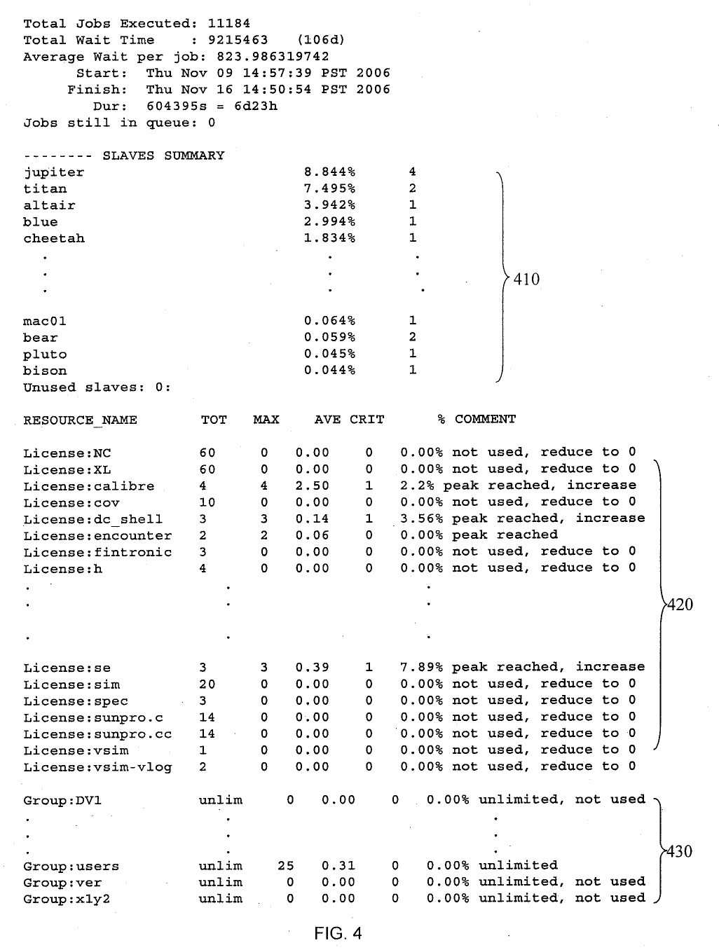

In an embodiment of the invention, the generated simulation data further includes the use of hardware and software resources in the compute farm. An example of simulation data is provided in FIG. 4. As can be seen in FIG. 4., a total number of 11,184 jobs were submitted, the total cumulative wait time was 106 days, and the average wait time per job was 823.9 seconds.

Lines labeled as 410 include use data of computer resources in the farm. For example, the line:

“jupiter 8.84% 4”
means that a remote computer “jupiter” has four CPUs, therefore it can execute four jobs at the same time. The “jupiter” computer was used at 8.84% of capacity. Lines labeled as 420 include utilization data of software resources, e.g. licenses. For example, the line:
“License: calibre 4 4 2.5% 1 2.2% peak reached, increase”
indicates that there are four licenses of type caliber, and all of them have been used at some point during the simulation period. The licenses were used at a mere 2.5% from the available capacity. The 2.2% is a measure of the unmet demand, i.e. the time that jobs were waiting for a calibre license. That is, even if the overall use of the license is low (2.5%), the fraction of the time during which queued jobs are held back because of insufficient licenses is positive and comparable to the use. This provides an indication that increasing the number of calibre licenses is likely to have an impact on the overall wait time of jobs using calibre licenses. Lines labeled as 430 include statistics on groups, as mentioned in detail above.

Once the simulation data are presented, the user can perform sensitivity analysis in response to a plurality of “what-if” scenarios. For example, the user may decide to add or remove a software resource, to add or remove a remote computer of a certain type, and so on. Upon selection of a scenario the simulation process is executed as described above and significant performance changes are reported. In addition, the output of the sensitivity analysis may also include monetary information, such as the cost for upgrading the farm, return on investment (ROI), and so on.

In accordance with another embodiment, a method for simulating the workflow in a computing farm is disclosed. That is, the same simulation data mentioned in detail above is produced in response to jobs that are interdependent. With this aim, simulation workload information is replaced with workflow information and the scheduler takes into account the dependency between jobs when scheduling jobs for execution.

The present invention has been described with a reference to a specific embodiment where the simulator is based on an event-driven scheduler where the latency parameters are set to zero. However, it be will apparent to a person skilled in the art that, by tuning the latency parameters, the simulation process of the invention can also emulate the operation of the farm's scheduler, which may be, but is not limited to, a batch scheduler within LSF, or a batch scheduler provided by OpenPBS, and the like.

The methods and processes described herein can be implemented in software, hardware, firmware, or combination thereof.

Although the invention is described herein with reference to the preferred embodiment, one skilled in the art will readily appreciate that other applications may be substituted for those set forth herein without departing from the spirit and scope of the present invention. Accordingly, the invention should only be limited by the Claims included below.

1. A computer implemented method for simulating a workload of a compute farm, comprising the steps of:
receiving input data related to attributes of the compute farm to be simulated;
executing a simulator process to simulate at least the compute farm's attributes;
outputting simulation data; and
analyzing said simulation data.

2. The method of claim 1, wherein the data related to attributes of the compute farm comprise at least one of:
a list of hardware resources of the compute farm;
a list of software resources of the compute farm;
historical data on jobs to be executed on the compute farm; and
workload information.

3. The method of claim 2, wherein input data related to each of the software resources comprise at least one of the following attributes:
a name,
a type,
a creation time,
an expiration time, and
an availability of the software resource.

4. The method of claim 3, wherein input data related to each of the hardware resources comprise at least one of the following attributes:
a computer name,
a creation time,
an expiration time,
a computing power index,
an operating system type, memory size,
a central processing unit (CPU) speed, and
a number of CPUs.

5. The method of claim 4, wherein the computing power index comprises a normalized number that determines at least a processing speed of a job on a reference remote computer relative to the hardware resource.

6. The method of claim 2, wherein the historical data comprise for each job at least the following attributes:
a submission time,
resources required for execution of the job,
an owner of the job,
a job class, and
an expected duration time of execution.

7. The method of claim 2, wherein the workload information determines an order of submitting jobs for execution.

8. The method of claim 2, wherein the simulator process further comprises performing the steps of:
submitting jobs for execution according to an order designated in the workload information;
scheduling execution of the jobs;
calculating an execution time of each job; and
generating the simulation data when completing the execution of all jobs.

9. The method of claim 8, wherein submitting jobs for execution further comprises performing the steps of:
creating a simulation event; and
saving the simulation event in a simulation queue.

10. The method of claim 9, wherein scheduling the execution of jobs further comprises performing at least one of the steps of:
selecting a simulation event with the smallest timestamp; and
dispatching a queued job for execution on a remote computer when the simulation event triggers a request to call a scheduler of the farm computer.

11. The method of claim 10, wherein the jobs are scheduled to execution according to a policy carried out by the scheduler of the compute farm.

12. The method of claim 10, wherein execution time is computed using an expected duration time of the job and a relative power of the remote computer.

13. The method of claim 12, wherein the expected duration time is an expected execution time of the job on a remote computer with a normalized power index.

14. The method of claim 8, wherein the simulation data are generated for a group of jobs and comprise at least:
an average execution duration,
an average waiting time,
a maximum waiting time,
a submission time of a first job in the group of jobs,
a start time of a first job,
a completion time of a last job, and
a number of jobs that were not executed.

15. The method of claim 14, where the simulation data further comprise data on use of the hardware resources and software resources of the compute farm.

16. The method of claim 15, further comprising performing a sensitivity analysis step on the generated simulation data.

17. The method of claim 16, wherein the sensitivity analysis provides at least monetary information about the use of hardware resources and software resources in the compute farm.

18. A computer program product for enabling operation of a method for simulating a workload of a compute farm, the computer program product having computer instructions on a computer readable medium, the instructions executing a computer implemented method comprising the steps of:
receiving input data related to attributes of a compute farm to be simulated;
executing a simulator process to simulate at least the compute farm's attributes;
outputting simulation data; and
analyzing said simulation data.

19. The computer program product of claim 18, wherein the data related to attributes of the compute farm comprise at least one of:
a list of hardware resources of the compute farm;
a list of software resources of the compute farm;
historical data on jobs to be executed on the compute farm; and
workload information.

20. The computer program product of claim 18, wherein input data related to each of the software resources comprise at least one of the following attributes:
a name,
a type,
a creation time,
an expiration time, and
an availability of the software resource.

21. The computer program product of claim 20, wherein input data related to each of the hardware resources comprises at least one of the following attributes:
a computer name,
a creation time,
an expiration time,
a computing power index,
an operating system type,
memory size,
a central processing unit (CPU) speed, and
a number of CPUs.

22. The computer program product of claim 21, wherein the computing power index comprises a normalized number that determines at least a processing speed of a job on a reference remote computer relative to the hardware resource.

23. The computer program product of claim 19, wherein the historical data comprise for each job at least the following attributes:
a submission time,
resources required for execution of the job,
an owner of the job,
a job class, and
an expected duration time of execution.

24. The computer program product of claim 19, wherein the workload information determines an order of submitting jobs for execution.

25. The computer program product of claim 19, wherein the simulator process further performs steps comprising:
submitting jobs for execution according to an order designated in the workload information;
scheduling the execution of the jobs;
calculating an execution time of each job; and
generating the simulation data when completing the execution of all jobs.

26. The computer program product of claim 25, wherein submitting jobs for execution further comprises performing the steps of:
creating a simulation event; and
saving the simulation event in a simulation queue.

27. The computer program product of claim 26, wherein scheduling the execution of jobs further comprises performing at least one of the steps of:
selecting a simulation event with the smallest timestamp; and
dispatching a queued job for execution on a remote computer when the simulation events triggers a request to call a scheduler of the compute farm computer.

28. The computer program product of claim 27, wherein the jobs are scheduled to execution according to a policy carried out by the scheduler of the compute farm.

29. The computer program product of claim 27, wherein execution time is computed using an expected execution duration time of the job and a relative power of the remote computer.

30. The computer program product of claim 29, wherein the expected duration time is an expected execution time of the job on a remote computer with a normalized power index.

31. The computer program product of claim 25, wherein simulation data are generated for a group of jobs and comprise at least:
an average execution duration,
an average waiting time,
a maximum waiting time,
a submission time of a first job in the group of jobs,
a start time of a first job, a completion time of a last job, and
a number of jobs that were not executed.

32. The computer program product of claim 31, where the simulation data further comprise data on use of the hardware resources and software resources of the compute farm.

33. The computer program product of claim 32, further comprising performing a sensitivity analysis step on the generated simulation data.

34. The computer program product of claim 33, wherein the sensitivity analysis provides at least monetary information about the use of hardware resources and software resources in the compute farm.
